(19) United States
(12) Patent Application Publication
(10) Pub. No.: US 2018/0297699 A1
(43) Pub. Date: Oct. 18, 2018

(54) OVERHEAD TETHERED DRONE SYSTEM

(71) Applicant: Mesa Digital, LLC, Albuquerque, NM (US)

(72) Inventors: Luis M. Ortiz, Albuquerque, NM (US); Kermit D. Lopez, Albuquerque, NM (US)

(21) Appl. No.: 15/956,340

(22) Filed: Apr. 18, 2018

Related U.S. Application Data
(60) Provisional application No. 62/486,652, filed on Apr. 18, 2017.

(51) Int. Cl. B64C 39/02; G05D 1/00; G05D 1/10

(52) U.S. Cl. CPC B64C 39/022; B64C 39/024; G05D 1/0094; B64C 2201/06; B64C 2201/127; B64C 2201/148; G05D 1/101

(57) ABSTRACT

An overhead tethered drone system can include a least one camera-bearing drone tethered by a retractable electrical power carrying tether line to a retraction assembly attached to venue infrastructure located above a live activity occurring within the venue. Controlling x-y-z orientation of the camera bearing drone can be accomplished via power to drone propellers and/or a tether line retraction motor located in the retraction assembly attached above the drone to venue infrastructure (e.g., ceiling rafters). Control over drone movement can be conducted remotely from a remote controller (e.g., control booth) while capturing high definition images of perspective within the venue by one or more drone cameras. Video images captured by the camera bearing drone can be provided to at least one of a production server or mobile devices via a wired and/or wireless data network where the images can be processed and rendered on display screens viewable by media directors, editors and spectators located either at the venue or remote from the venue (e.g., at home).

### INVENTION PRIORITY

The present embodiments claim priority as a continuation of provisional patent application Ser. No. 62/486,652, filed Apr. 18, 2017, entitled “Overhead Tethered Drone System,” which is incorporated herein fully for its teaching.

### TECHNICAL FIELD

Embodiments are generally related to unmanned aerial vehicles (“UAVs”), which are also commonly referred to as “drones.” Embodiments are also related to venue-based multimedia systems including cameras deployed around a venue to capture video of live action occurring at venues. More particularly, embodiments of the invention are related to drone use within an entertainment venue to capture video from above action taking place on the floor or ground of a venue.

### BACKGROUND

A drone is an unmanned aerial vehicle (UAV) utilized for many purposes, including: video land surveillance, intelligence gathering, environmental monitoring, package transport, munitions delivery, and entertainment. UAVs can transport medicines and vaccines, and retrieve medical samples, into and out of remote or otherwise inaccessible regions. “Ambulance drones” can rapidly deliver defibrillators in the crucial few minutes after cardiac arrests, and include live stream communication capability allowing paramedics to remotely observe and instruct on-scene individuals in how to use the defibrillators. UAVs can be connected to a Cloud Software that aggregates weather, terrain and airspace data, and creates geo-fenced aerial routes for safe flight. A drone system can even be controlled by a smartphone with an App (software application).

The duration of drone use is limited because of their dependence on batteries and battery life. Drone usage within populated areas is also of concern given the risk of a malfunction or power outage causing a drone to fall onto civilians and causing injury. Drones are, however, very flexible when used to gather video data from multiple perspectives given their x, y, z movement and agility. The only robotic camera in wide use during American football games is limited to forward and backward movement on a fixed line and along a single axis (e.g., along the length of a football field). There are so many other perspectives of an activity that could be captured it technology was available to provide them. What is needed is a system that can enable secure and sustained use of video-enable drones within live entertainment venues in order to capture more perspectives of an activity.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is a feature of the disclosed embodiments to provide a drone-based system for deployment around a live activity occurring at a live venue in order capture multiple perspectives of the activity that have not been possible using conventional venue technology. It is therefore a feature of the disclosed embodiments to provide an overhead tethered drone system.

It is a feature of the embodiments to provide an overhead tethered drone system including at least one drone including more than one propeller tethered by a retractable, electrical power carrying tether line to a tether line retraction assembly attachable to venue infrastructure located above the drone and a live activity occurring within the venue. The power carrying tether line can supply electrical power to the at least one drone so that it can sustain operation for long periods of time rather than relying on battery power.

It is also a feature of the embodiments to provide a controller configured to control x-y-z orientation of the camera bearing drone, wherein x-y-z orientation can be accomplished via electrical power applied to the more than one propeller.

It is also a feature of the embodiments to provide at least one camera in the drone for capturing video images of at least one perspective of the live activity and providing the video images to a remote client.

It is also a feature of the embodiments that a tether line retraction motor can be included in the retraction assembly, wherein z orientation can be further controlled via power applied to the tether line retraction motor.

It is also a feature of the embodiments that a client receiving the video images from the at least one camera can be a production server and the video images can be provided via a data network. The data network can be at least one of a local area network, WI-FI network, and cellular data network.

It is also a feature of the embodiments that the tether line can provide electrical power and wired data communications to the drone.

It is also a feature of the embodiments that the client receiving the video images from the at least one camera can be at least one mobile devices and the video image can be provided via a wireless data network including at least one of a WI-FI network and cellular data network.

It is also a feature of the embodiments that a control booth including a client can provide remote control over navigation of the drone.

It is also a feature of the embodiments that a mobile device can provide remote control over navigation of the drone.

It is also a feature of the embodiments that a track can be provided on venue ceiling rafters for movably coupling the retraction assembly to the ceiling rafters at the venue, and that the tether line retraction assembly can move about the track in at least one of x and y directions.

### BRIEF DESCRIPTION OF THE DRAWINGS

The accompanying figures, in which like reference numerals refer to identical or functionally similar elements throughout the separate views and which are incorporated in and form a part of the specification, further illustrate the disclosed embodiments and, together with the detailed description of the invention, serve to explain the principles of the disclosed embodiments.

FIG. 1 illustrates an overhead tethered drone system, in accordance with features of the embodiments.

FIG. 2 illustrates overhead tethered drone system including more than one drone deployed at a venue, in accordance with additional features of the embodiments.

FIG. 3 illustrates top view of a venue employing an overhead tethered drone system including at least four drones, in accordance with features of the embodiments.

FIG. 4 illustrates a top view of more than one overhead tethered drone operation with collision avoidance while capturing images of a live activity at a venue, in accordance with features of the embodiments.

FIG. 5 illustrates a block diagram of some components for an overhead tethered drone system, in accordance with features of the embodiments.

FIG. 6 illustrates a flow diagram of a method of employing an overhead tethered drone system, in accordance with the embodiments.

### DETAILED DESCRIPTION

U.S. Pat. Nos. 7,149,549, 8,320,820, 8,870,895, and 8,750,784 are herein incorporated by reference for their teachings. U.S. patent application Ser. No. 15/363,008 is also incorporated herein by reference it its entirety for its teaching as well. Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing,” “computing,” “calculating.” “determining,” “establishing,” “analyzing,” “checking,” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an example embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a smart watch, wearable computing devices, a server computer, a handheld computer, a handheld device, a Personal Digital Assistant (PDA) device, a handheld PDA device, an on-board device, an off-board device, a hybrid device, and RFID-enabled device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a cellular network, a cellular node, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Note that the term “server” as utilized herein refers generally to a computer that provides data to other computers. Such a server can serve data to systems on, for example, a LAN (Local Area Network) or a wide area network (WAN) over the Internet. Many types of servers exist, including web servers, mail servers, and files servers. Each type can run software specific to the purpose of the server. For example, a Web server may run Apache HTTP Server or Microsoft IIS, which both provide access to websites over the Internet. A mail server may run a program such as, for example, Exim or iMail, which can provide SMPT services for sending and receiving email. A file server might utilize, for example, Samba or the operating system's built-in file sharing services to share files over a network. A server is thus a computer or device on a network that manages resources. Other examples of servers include print servers, database servers and so on. A server may be dedicated, meaning that it performs no other tasks besides their server tasks. On multiprocessing operating systems, however, a single computer can execute several programs at once. A server in this case may refer to the program that is managing resources rather than the entire computer.

Some embodiments may be used in conjunction with devices and/or networks operating in accordance with existing Long Term Evolution (LTE) specifications, e.g., “3GPP TS 36.304 3rd Generation Partnership Project; Technical Specification Group Radio Access Network; Evolved Universal Terrestrial Radio Access (E-UTRA); User Equipment (UE) procedures in idle mode”; “3GPP TS 36.331 3rd Generation Partnership Project; Technical Specification Group Radio Access Network; Evolved Universal Terrestrial Radio Access (E-UTRA); Radio Resource Control (RRC); Protocol specification”, “3GPP 24.312 3rd Generation Partnership Project; Technical Specification Group Core Network and Terminals; Access Network Discovery and Selection Function (ANDSF) Management Object (MO)”; and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee®, Ultra-Wideband (UWB), Global System for Mobile communication (GSM), second generation (2G), 2.5G, 3G, 3.5G, 4G, 5G, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1.times.RTT), Evolution-Data Optimized (EV-DO), Enhanced Data rates for GSM Evolution (EDGE), and the like. Other embodiments may be used in various other devices, systems and/or networks.

The phrase “hand held device” and/or “wireless device” and/or “mobile device” and/or “portable device,” as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the phrase “wireless device” and/or “mobile device” may optionally include a wireless service and may also refer to wearable computing devices such as smartwatches and eyeglass computing devices (e.g., Google Glass, etc.).

A “hand held device” or HHD is a type of mobile device or wireless device, which can be held in one's hand during use, such as a smart phone, personal digital assistant (PDA), tablet computing device, laptop computer and the like. It can be appreciated that such devices are not hand held devices and do not constitute an HHD since they are not used as “hand held devices” but as other types of computing devices, such as wearable computing devices. The example embodiments herein primarily describe methods and systems involving hand held devices. It can be appreciated, however, that other mobile devices such as wearable computing devices can be utilized in place of a hand held device (wearable devices are not “hand held devices” because are intended to be used in a user's hands but instead worn by the user) or may be utilized with other hand held devices. For example, venue-based data as discussed herein can be streamed not only to hand held devices but also to other mobile computing devices such as wearable computing devices. Such data may be streamed to client devices such as mobile devices (e.g., hand held computing devices such as smartphones, laptop computers and table computing devices) that are located at the venue or located elsewhere (e.g., at home, in a car, in another state or country, etc.).

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a LTE cellular system. However, other embodiments may be implemented in any other suitable cellular network, e.g., a 3G cellular network, a 4G cellular network, a 5G cellular network, a WiMax cellular network, and the like.

The term “antenna,” as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The terms “cell” or “cellular,” as used herein, may include a combination of network resources, for example, downlink and optionally uplink resources. The resources may be controlled and/or allocated, for example, by a cellular node (also referred to as a “base station”), or the like. The linking between a carrier frequency of the downlink resources and a carrier frequency of the uplink resources may be indicated, for example, in system information transmitted on the downlink resources.

Access points, which are often interconnected by cabling, generally play a dominant role in providing radio frequency (RF) coverage in most wireless LAN (WLAN) deployments. Wireless repeaters, though, are an alternative way to extend the range of an existing WLAN instead of adding more access points. There are very few stand-alone 802.11 wireless repeaters on the market, but some access points have a built-in repeater mode. The wireless communications electronics representing access points and wireless repeaters will be referred to herein as communications system nodes, or simply as communications nodes.

In general, a repeater simply regenerates a network signal in order to extend the range of the existing network infrastructure. A WLAN repeater does not physically connect by wire to any part of the network. Instead, it receives radio signals (802.11 frames) from an access point, end user device, or another repeater and retransmits the frames. This makes it possible for a repeater located in between an access point and distant user to act as a relay for frames traveling back and forth between the user and the access point.

As a result, wireless repeaters are an effective solution to overcome signal impairments such as RF attenuation. For example, repeaters provide connectivity to remote areas that normally would not have wireless network access. In venue deployments, temporary placement and large areas requiring coverage can result in access points that don't quite cover areas where spectators using hand held devices desire connectivity. The placement of a repeater between the covered and uncovered areas, however, can provide connectivity throughout most of the venue space. The wireless repeater fills holes in coverage, enabling seamless roaming. Although the most modern venues includes built-in wireless infrastructure, older venues often require retrofitting to incorporate wireless communications equipment, or the equipment will only be temporary and must be installed just before an event. Temporary use will be typical with some operations. One or more embodiments can provide a system that simplifies the temporary or retrofit placement of wireless data communications equipment as drone recovery system throughout an area of operation.

Note that the term “venue” as utilized herein can refer to a place where something happens, especially an organized event such as a concert, conference, or sports event. Examples of a venue are sports stadiums and sports arenas, concert halls, convention centers, casinos, the Olympics, baseball stadiums, basketball arenas, football stadiums, hockey stadiums, concert arenas, television studios where live events are taped for live or later rebroadcast of the taping, and so on.

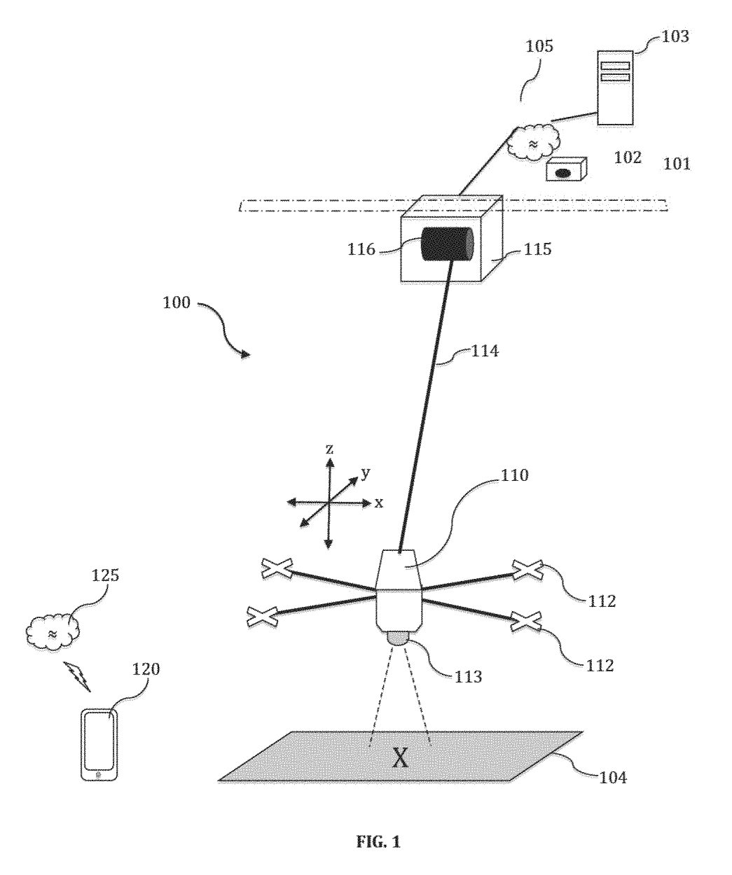

Referring to FIG. 1, an overhead tethered drone system 100 in accordance with features of the embodiments is illustrated. An overhead tethered drone system 100 can include a drone 110 including propellers 112 for causing z-y-z orientation and a camera 113 for capturing images of activity (indicated by “x”) occurring at a venue 104. The done 110 can be tethered by a tether line 114 to a tethered housing 115 that can include a motor 116 for drawing into the tether housing 115 or letting out the tether line 114 from the tether housing 115 (and thereby adjusting the length of the tether line, or its “z” position). The tether line 114 limits the distance of drone 110 over the activity and any spectators in attendance at the venue 104. This limit is an important safety feature of the system 100, and should serve to encourage its use by venue operators concerned over liability from falling drones.

The tether line 114 can also provide electrical power to the drone 110 from a connection to venue power 102 (e.g., electrical power plugs or wiring). The tether line can also provide data network 105 connectivity, which can enable the drone 110 and camera to communicate with a remote client 103 (e.g., server at a control booth or located remotely from the venue). It is also possible that mobile devices 120 can communicate with a local data network (e.g., WI-FI) or via cellular data network to obtain and process video image captured by the camera 113 for display at the mobile device 120. Mobile devices 120 can be located at the venue 104 (so WI-FI connectivity can be utilized), or remote from the venue (therefore cellular data connectivity would be useful). The tether housing 115 can be mounted to venue infrastructure 101 located above the live activity. Venue infrastructure can include rafters, racks or the like, which typically support cover and lighting at venues.

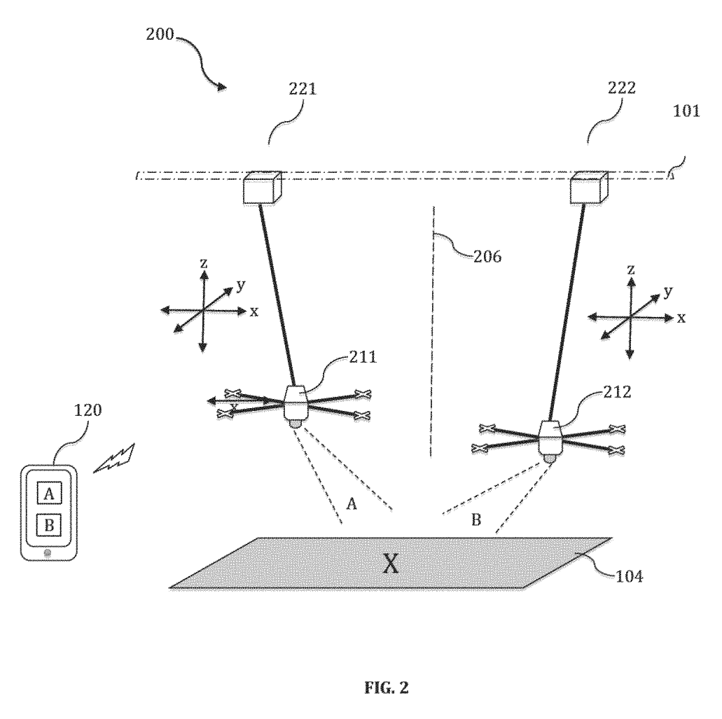

FIG. 2 illustrates a schematic diagram of an overhead tethered drone system 200 including more than one drone 211/212 deployed over an activity at a venue 104, in accordance with additional features of the embodiments. Drone 211 is shown tethered to tether housing 221. Note that the term “drone” as utilized herein can refer to a robotic vehicle such as a UAV (Unmanned Aerial Vehicle), a UCAV (Unmanned Combat Aerial Vehicle), a UGV (Unmanned Ground Vehicle) such as, for example, an autonomous car, a USV (Unmanned Surface Vehicle), an AUV (Autonomous Underwater Vehicle) and so on. Examples of a UAV include a multirotor, a quadropter, and so on. A UAV is an aircraft without a human pilot aboard. UAVs can be a component of a UAS (Unmanned Aircraft System), which may include a UAV, a ground-based controller, and a system of communications between the two. The flight of UAVs may operate with various degrees of autonomy: either under remote control by a human operator, or fully or intermittently autonomously, by onboard computers.

Drone 212 is shown tethered to tether housing 222. Drones 221 and 222 can operate up to a limit 206 in order to avoid collision. Collision avoidance can be established when mounting overhead tethered drones to venue infrastructure 101, can be programmed into drones or managed by a remote controller of the drones during operation, and can be assisted with drone-based sensors. Again, the tether lines 114 can limit the distance of drones over the activity and spectators at the venue 104, thereby providing safety over the system's use by venue operators at live events. Also shown in FIG. 2 is a mobile device 120. It is conceivable that the mobile device 120 can receive images directly from drones 211 and 212 via local wireless connectivity. As shown in the mobile device screen, a mobile device user can select between viewpoint A (drone 211) or viewpoint B (drone 222) for rendering as video. It should also be appreciated that the mobile device can be located far and remote from the venue, but can still make a selection between A and B via authorized connection to a server 103.

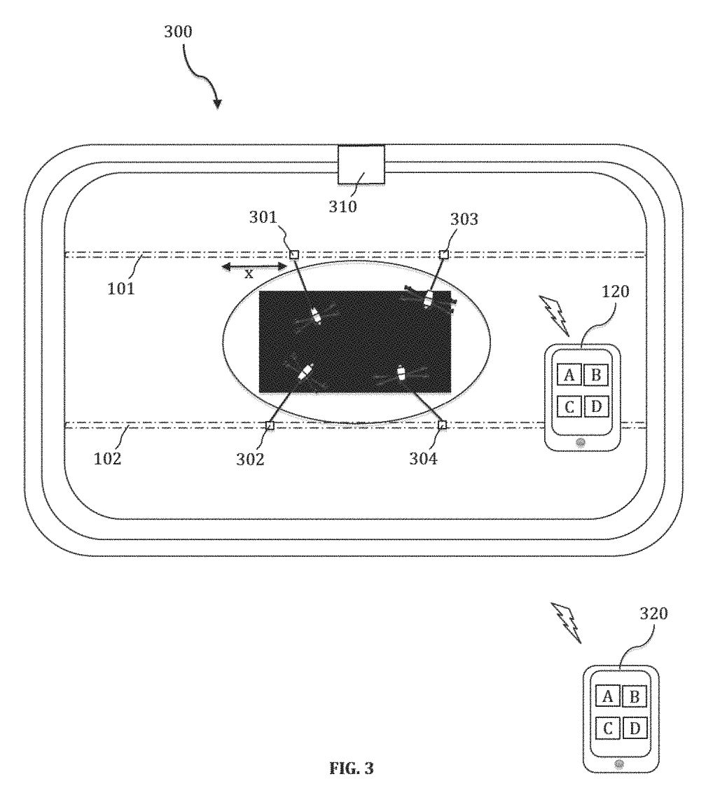

Referring to FIG. 3, illustrated is top view of a venue 300 employing an overhead tethered drone system including at least four drones 301-304 with tether lines and housings, in accordance with features of the embodiments. The housings for each drone are shown mounted to venue infrastructure 101 and 102. Also shown in associated with drone 301 is x-axis movement of the housing 301. It is a feature that the housings can be moveably mounted onto tracks that are fixably mounted to venue infrastructure (e.g., rafters, light supports). In this manner, additional x-axis movement of drones can be accomplished over the activity. Also shown in FIG. 3 is a mobile device 120 located within the venue, and a mobile device 320 located outside of the venue. Both mobile devices are shown wirelessly communicating (e.g., with drones or a server) to obtain four different perspective of the venue activity for rendering as packet video on displays screens associated with the mobile devices.

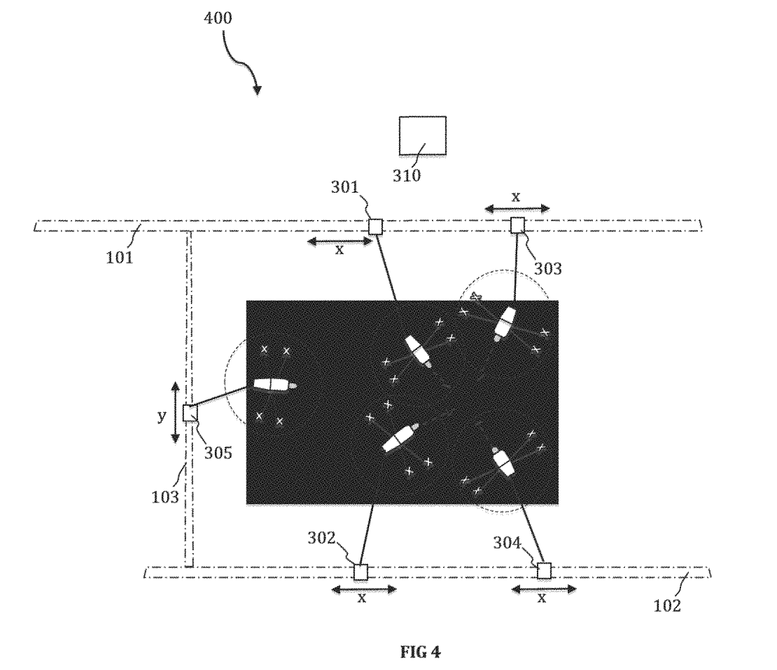

FIG. 4 illustrates a top view 400 of more than one overhead tethered drone in operation over an activity using collision avoidance (indicated by dashed circles) while capturing images of the live activity at a venue, in accordance with features of the embodiments. As shown, drones 301-304 can be moved along the x-axis of infrastructure 101/102 when mounted on tracks in association with the infrastructure 101/102. When moving via drone propellers 112, tether motors 116 or tether housings 116 on tracks, the drones can be controlled by a controller 310 (e.g., operators at the venue, such as in a control room) to assure that zone limits between drones are enforced to avoid collision. Enforcement can be further provided via computer assistance onboard drones or in the control section 310 (e.g., server 103). Also shown is a drone 305 capable of being moved in a y-axis with respect to the activity. The housing of drone 305 can be mounted to venue infrastructure 103 that is perpendicular to venue infrastructure 101/102.

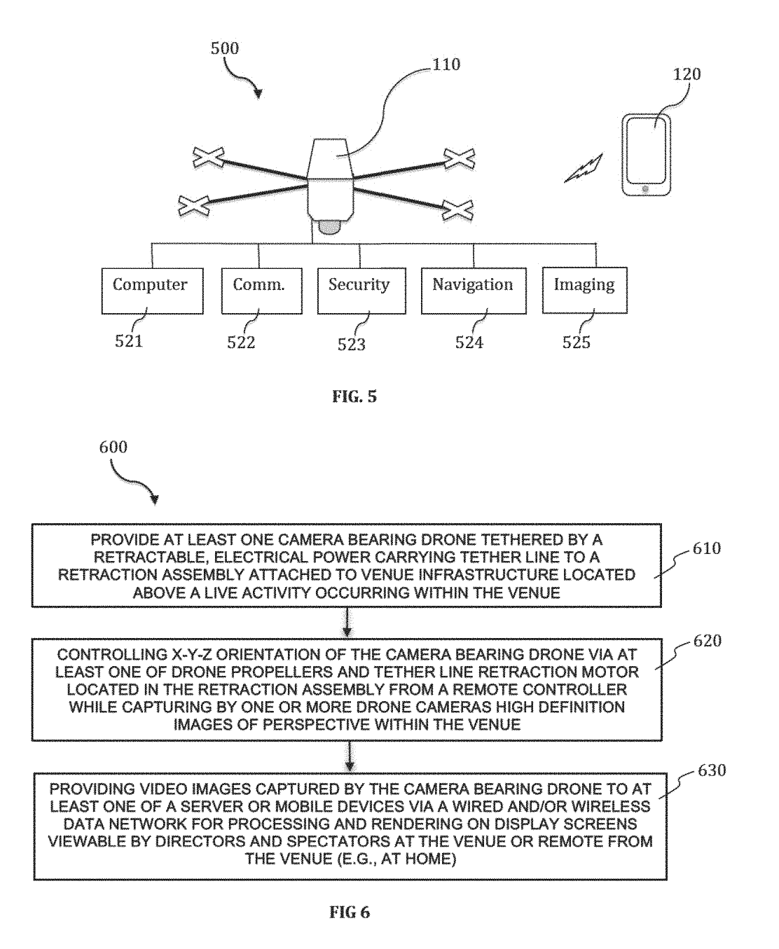

FIG. 5 illustrates a block diagram 500 of some components that can be located in an overhead tethered drone system, in accordance with features of the embodiments. A tether drone 110 can include an onboard computer 521 to manage functions and communications of the drone 110. Communications module 522 can enable wired or wireless data communications of the drone with remote clients (e.g., control room, mobile devices). A security module can limit drone access to authorized operators/personnel (e.g., hacking prevention, or imposing video access limitations to only authorized spectators). Navigation module 524 can assist with x-y-z control over the drone 110 during operation. Navigation module can also assist with collision avoidance by incorporated data from a combination of remote 310 controller input or onboard sensor inputs. Imaging module 525 can manage the capture, processing and transmission of video capture by the onboard camera 113.

FIG. 6 illustrates a flow diagram of a method of employing an overhead tethered drone system, in accordance with the embodiments. As shown in Block 610, at least one camera bearing drone tethered by a retractable electrical power carrying tether line to a retraction assembly attached to venue infrastructure locate above a live activity occurring within the venue can be provided. In Block 620, the x-y-z orientation of the camera bearing drone can be controlled by at least one of drone propellers and tether line retraction motor located in the retraction assembly from a remote controller while capturing high definition images within the venue by one of more drone cameras. Then, as shown in Block 630, video images captured by the camera bearing drone can be provided to at least one of a server or mobile devices via a wired and/or wireless data network for processing and rendering on display screens viewable by directors and spectators at the venue or remote from the venue (e.g., at home).

It can be appreciated that the claims, description, and drawings of this application may describe one or more of the instant technologies in operational/functional language, for example as a set of operations to be performed by a computer (e.g., computer 521) Such operational/functional description in most instances can be specifically-configured hardware (e.g., because a general purpose computer in effect becomes a special-purpose computer once it is programmed to perform particular functions pursuant to instructions from program software). Note that the computer (e.g., computer 521) or data-processing system discussed herein may be implemented as special-purpose computer in some example embodiments. In some example embodiments, such data-processing system or computer can be programmed to perform the aforementioned particular instructions thereby becoming in effect a special-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, java, visual basic), etc.), or tools in the form of very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices. mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modem microprocessor will often contain more than one hundred million logic gates in its many logic circuits (and often more than a billion transistors).

The logic circuits forming the microprocessor are arranged to provide a micro architecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state, may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Based on the foregoing, it can be appreciated that a number of example embodiments are disclosed herein. For example, in one embodiment an overhead tethered drone system, can be implemented, which includes at least one drone composed of more than one propeller tethered by a retractable, electrical power carrying tether line to a tether line retraction assembly attachable to venue infrastructure located above the drone and a live activity occurring within the venue, wherein the power carrying tether line supplies electrical power to the at least one drone; a controller configured to control x-y-z orientation of the camera bearing drone, wherein x-y-z orientation can be accomplished via electrical power applied to the more than one propellers; and a least one camera included in the drone for capturing video images of at least one perspective of the live activity and providing the video images to a remote client.

In some example embodiments, the disclosed system can include a tether line retraction motor included in the retraction assembly, wherein z orientation can be further controlled via power applied to the tether line retraction motor. In another example embodiment, the client receiving the video images from the at least one (“one or more”) camera is a production server and the video images are provided via a data network. In yet another example embodiment, the aforementioned data network can be one or more of a local area network, a WI-FI network, and a cellular data network. In another example embodiment, the aforementioned tether line can be configured to provide electrical power and wired data communications to the drone.

In another example embodiment, the client receiving the video images from the at least one camera is at least one mobile device and the video image can be provided via a wireless data network including at least one of a WI-FI network and cellular data network. In other words, the wireless data network may be a WI-FI network in combination with a cellular data network or may be just a WI-FI network or just a cellular network. In other example embodiments, the at least one mobile device can communicate with both types of networks.

In some example embodiments, the aforementioned system can include a control booth including a client providing remote control over navigation of the drone. In another example embodiment, a mobile device can provide remote control over navigation of the drone. In some example embodiments, a track can movably couple the retraction assembly to ceiling rafters at the venue, wherein the tether line retraction assembly can move about the track in at least one of x and y directions.

In another example embodiment, a tethered drone system attachable above a live activity to venue infrastructure located above the live activity, can be implemented, which includes, for example, at least one drone including at least four propellers tethered by a retractable tether line configured to provide electrical power from a power source to the at least one drone, the retractable tether line controlled supported and controlled in length by a tether line retraction motor included in the tether line retraction assembly attachable, wherein the tether line retraction assembly is attachable to venue infrastructure located above the drone and a live activity occurring within the venue; a remote controller configured to control x-y-z orientation of the camera bearing drone, wherein x-y-z orientation can be accomplished via electrical power applied to the at least four propellers and the retraction motor; and a least one camera included in the drone for capturing video images of at least one perspective of the live activity and providing the video images to a remote client.

In yet another example embodiment, a method of providing multiple perspective of live activity occurring at a venue using drones, can be implemented, which includes steps, instructions or operations such as: providing at least one drone including at least one camera, more than one propeller, and tethered by a retractable, electrical power carrying tether line to a tether line retraction assembly attachable to venue infrastructure located above the drone and a live activity occurring within the venue, wherein the power carrying tether line supplies electrical power to the at least one drone and limits its descent towards spectators and the live activity at the venue; controlling x-y-z orientation of the at least one drone by applying electrical power remotely from a remote controller to the more than one propellers; and capturing video images of at least one perspective of the live activity using at least one camera integrated in the drone; and providing the video images to a remote client.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. An overhead tethered drone system, comprising:
at least one drone including more than one propeller tethered by a retractable, electrical power carrying tether line to a tether line retraction assembly attachable to venue infrastructure located above the drone and a live activity occurring within the venue, wherein the power carrying tether line supplies electrical power to the at least one drone;
a controller configured to control x-y-z orientation of the camera bearing drone, wherein x-y-z orientation can be accomplished via electrical power applied to the more than one propellers; and
at least one camera included in the drone for capturing video images of at least one perspective of the live activity and providing the video images to a remote client.

2. The system of claim 1, further comprising a tether line retraction motor included in the retraction assembly, wherein z orientation can be further controlled via power applied to the tether line retraction motor.

3. The system of claim 1, wherein the client receiving the video images from the at least one camera is a production server and the video images are provided via a data network.

4. The system of claim 3, wherein the data network is at least one of a local area network, WI-FI network, and cellular data network.

5. The system of claim 4, wherein the tether line provides electrical power and wired data communications to the drone.

6. The system of claim 1, wherein the client receiving the video images from the at least one camera is at least one mobile devices and the video image are provided via a wireless data network including at least one of a WI-FI network and cellular data network.

7. The system of claim 1, further comprising a control booth including a client providing remote control over navigation of the drone.

8. The system of claim 1, further comprising a mobile device providing remote control over navigation of the drone.

9. The system of claim 1, further comprising a track movably coupling the retraction assembly to ceiling rafters at the venue, wherein the tether line retraction assembly can move about the track in at least one of x and y directions.

10. A tethered drone system attachable above a live activity to venue infrastructure located above the live activity, comprising:
at least one drone including at least four propellers tethered by a retractable tether line configured to provide electrical power from a power source to the at least one drone, said retractable tether line controlled supported and controlled in length by a tether line retraction motor included in the tether line retraction assembly attachable, wherein the tether line retraction assembly is attachable to venue infrastructure located above the drone and a live activity occurring within the venue;
a remote controller configured to control x-y-z orientation of the camera bearing drone, wherein x-y-z orientation can be accomplished via electrical power applied to the at least four propellers and the retraction motor; and
at least one camera included in the drone for capturing video images of at least one perspective of the live activity and providing the video images to a remote client.

11. The system of claim 10, wherein the remote client receiving the video images from the at least one camera is a production server and the video images are provided via a data network further comprising at least one of a local area network, WI-FI network, and cellular data network.

12. The system of claim 11, wherein the tether line provides wired data communications to the drone.

13. The system of claim 10, wherein the remote client receiving the video images from the at least one camera is at least one mobile devices and the video image are provided via a wireless data network including at least one of a WI-FI network and cellular data network.

14. The system of claim 10, wherein the remote controller further comprises a client located in a control booth receiving video images from the at least one camera on the drone and providing remote control over navigation of the drone.

15. The system of claim 1, wherein the remote controller further comprises a mobile device providing remote control over navigation of the drone.

16. The system of claim 1, further comprising a track movably coupling the retraction assembly to ceiling rafters at the venue, wherein the tether line retraction assembly can move about the track in at least one of x and y directions.

17. A method of providing multiple perspective of live activity occurring at a venue using drones, comprising:
providing at least one drone including at least one camera, more than one propeller, and tethered by a retractable, electrical power carrying tether line to a tether line retraction assembly attachable to venue infrastructure located above the drone and a live activity occurring within the venue, wherein the power carrying tether line supplies electrical power to the at least one drone and limits its descent towards spectators and the live activity at the venue;
controlling x-y-z orientation of the at least one drone by applying electrical power remotely from a remote controller to the more than one propellers; and
capturing video images of at least one perspective of the live activity using at least one camera integrated in the drone; and
providing the video images to a remote client.

18. The system of claim 17, wherein the remote controller further comprises a client located in a control booth receiving video images from the at least one camera on the drone and providing remote control over navigation of the drone.

19. The system of claim 17, wherein the remote controller further comprises a mobile device providing remote control over navigation of the drone.

20. The system of claim 17, further comprising a track movably coupling the retraction assembly to ceiling rafters at the venue, wherein the tether line retraction assembly can also move about the track in at least one of x and y directions.
